(19) United States
(12) Patent Application Publication
(10) Pub. No.: US 2004/0162888 A1
(43) Pub. Date: Aug. 19, 2004

(54) Remote access to a firmware developer user interface

(76) Inventors: Jason W. Reasor, Frisco, TX (US); Bradley G. Culter, Dallas, TX (US); Greg Albrecht, Plano, TX (US)

Correspondence Address: HEWLETT-PACKARD DEVELOPMENT COMPANY, Intellectual Property Administration, P.O. Box 272400, Fort Collins, CO, 80527-2400, US

(21) Appl. No.: 10/369,280

(22) Filed: Feb. 17, 2003

(51) Int. Cl. G06F 15/16

(52) U.S. Cl. 709/217

(57) ABSTRACT

A method for remote access to a firmware developer user interface in a multi-nodal computer system comprises registering a manageability subsystem with a server; booting the multi-nodal computer system; entering, by a truant cell of the multi-nodal computer system, into a remote developer user interface mode; writing, by the truant cell, a remote developer user interface initialization sequence to shared memory of the manageability subsystem; acknowledging, by a processor of the manageability subsystem, acceptance of the initialization upon the registering; sending an open session request to the server; and spawning an interactive developer user interface terminal session on the server.

### CROSS-REFERENCE TO RELATED APPLICATIONS

The present invention is related to currently filed, co-pending and commonly assigned, U.S. patent application Ser. No. ______ [Attorney Docket No. 100111710-1], entitled “FIRMWARE DEVELOPER USER INTERFACE”; and U.S. patent application Ser. No. ______ [Attorney Docket No. 100200765-1], entitled “FIRMWARE DEVELOPER USER INTERFACE WITH BREAK COMMAND POLLING”, the disclosures of which are incorporated herein by reference in their entireties.

### BACKGROUND

Many failure modes are possible in existing multi-nodal or cellular architecture computer systems. There are failure modes in multi-nodal computer systems that are not well supported within existing boot or initial program load (IPL) firmware. In multi-nodal computer systems, each system cell, or node, boots at a firmware level within the cell. The firmware of each cell then starts communicating with the firmware of other cells, with the goal of making one system, from the server operating system's (OS's) point of view, such that the cells are transparent, externally presenting the system as a single computer. This joining of cells is commonly referred to as rendezvous. Due to some sort of failure, such as a machine check abort (MCA), a cell or multiple cells may not make the rendezvous. In existing systems, that cell, or those cells, reboots and is/are unavailable to the system it was intended to join. In other words, in existing multi-nodal systems, if a cell does not make rendezvous it is left out of that system. As a result, a particular cell has a resource present in a cell that the system OS requires, and that cell fails to make rendezvous, the boot of the entire existing multi-nodal system may fail. Such a required resource may be the operating system disk drive, console universal asynchronous receiver/transmitter (UART) connector, local area network (LAN) system boot card, or the like.

Existing firmware user interfaces, designed to be accessed under normal boot conditions and/or from a system-wide perspective, have been implemented, but these interfaces cannot be invoked at the cell level during cell or system boot. Typically, for multi-nodal or cellular architecture server-class computers, when an error state arises during system start-up or boot, an available interactive interface with the system, known as the console, is invoked and is available to a user. Firmware specialist engineers or developers are often involved in the diagnosis of boot firmware related problems. However, a firmware specialist or developer is not typically able to gain access to the firmware via this system console. In existing multi-nodal computers, firmware runs at a very low level in each node and the console may not allow access into truant cells (i.e. cells that fail to reach system rendezvous). Only one console for all the cells in the system is typically provided in existing multi-nodal computer systems, and that console is “owned” by the OS running on the cells that successfully rendezvous. So hardware needed to control one or more specific truant cells, is not available for use by a user interface.

External tools have been used in the past to gather system information at the time of a system “crash”. For some existing systems, these external tools are used to pull information from the system in the event of a fatal error. These external tools themselves often require a reboot of the system to diagnose it. However, such interfaces are typically only available at a system level. Also, these tools must be designed to work correctly with the system under test. Problematically, these tools also require their own computer system on which to be run in order to provide useful information.

Additionally, existing implementations of firmware consoles have not allowed remote access to a boot firmware developer user interface (DUI). Existing implementations have had the capability to interrupt boot of a node of a multi-nodal computer system at the console for that node, but not from a remote location or other node.

### SUMMARY

An embodiment of method for remote access to a firmware developer user interface in a multi-nodal computer system comprises registering a manageability subsystem with a server; booting the multi-nodal computer system; entering, by a truant cell of the multi-nodal computer system, into a remote developer user interface mode; writing, by the truant cell, a remote developer user interface initialization sequence to shared memory of the manageability subsystem; acknowledging, by a processor of the manageability subsystem, acceptance of the initialization upon the registering; sending an open session request to the server; and spawning an interactive developer user interface terminal session on the server.

Another embodiment of a method for remote access to a firmware developer user interface in a multi-nodal computer system comprises assigning addresses to developer user interface ports in the multi-nodal computer system; routing the addresses to a developer user interface manageability subsystem of the multi-nodal computer system; booting the multi-nodal computer system; entering, by a user, an initiation command, indicating one of the addresses, in a terminal associated with the multi-nodal computer system; depacketizing, by the manageability subsystem, data from the terminal; polling by developer user interface of a truant cell of the multi-nodal computer system; and packetizing output of the developer user interface for communication to the terminal.

An embodiment of a system for remote access to a firmware developer user interface comprises at least one processor executing firmware in each cell of a multi-modal computer system; a developer user interface manageability subsystem providing a shared memory interface, the shared memory interface in turn providing an external interface for each of the cells of the computer system; and universal asynchronous receiver-transmitter functionality packetizing communications between the cells and between the cells and any net network attached to the computer system.

### BRIEF DESCRIPTION OF THE DRAWINGS

FIG. 1 is a diagrammatic view of a multi-nodal computer system employing an embodiment of a collaborative manageability subsystem for remote access to a developer user interface;

FIG. 2 is a high level flowchart of an external attached implementation embodiment of remote access to a firmware developer user interface; and

FIG. 3 is a high level flowchart of an internal demand initiation embodiment of remote access to a firmware development user interface.

### DETAILED DESCRIPTION

The present disclosure is, in general, directed to systems and methods which provide remote access to a boot firmware developer user interface (DUI) for a multi-nodal computer system. These systems and methods of remote access may employ a collaborative manageability subsystem. This subsystem may take the form of firmware that acts as an external interface for the multi-nodal computer system and/or individual cells or groups of cells. The subsystem may provide a shared memory interface between the system processors in the various cells or nodes. These processors may have access to the Internet or other networking. Coding of the collaborative manageability subsystem and the DUI firmware may allow the DUI to use a universal asynchronous receiver-transmitter (UART) interface and packetize communications between, from, and to the cells into a Telnet format or the like. Other communications may be employed by the remote access systems and methods to enable communication between, from, and to the cells such as universal serial bus (USB) connectivity or high performance serial bus connectivity, such as IEEE 1394 FireWire connectivity. Thus, with appropriate software in utilities infrastructure firmware, one console or one terminal may access any cell at any time and network access to the cells may be enabled.

In accordance with embodiments of the remote access systems and methods, a DUI for one or more cells in a multi-cell computer system is available upon boot failure or when called for, or invoked, by an engineer, developer or technician user during boot. From a developer's perspective, the DUI provides access to manipulate source level debugging as well as visibility into and control over intra-cell hardware and data structures and other information the firmware has created in order to boot and operate the cell or system properly. From a support engineer's perspective, the DUI provides an opportunity to deconfigure central processing units (CPUs), deconfigure memory, take hardware out of the boot process for a cell, or take other corrective action(s), so a cell, and ultimately the system, may boot. Such a DUI in discussed in greater detail in commonly owned, co-filed U.S. patent application Ser. No. ______ [Attorney Docket No. 100111710-1], entitled “FIRMWARE DEVELOPER USER INTERFACE”, the disclosure of which is incorporated by reference herein in its entirety. By implementing DUI remote access, a user, such as a developer or a firmware engineer, is provided access to a cell or system DUI via other cell consoles or network connectivity such as a LAN, the Internet, an intranet, or the like. The firmware itself may provide a diagnostic capability as well.

The DUI remote access systems and methods are particularly well suited for use in an INTEL® ITANIUM® processor family (IPF)-based multi-nodal computer system. However, as one skilled in the art will appreciate the DUI is adaptable for use in any number of multi-nodal computer systems and embodiments of the DUI remote access systems and methods may be implemented across multiple platforms. The DUI may provide interactive initiation control enabling interaction with the DUI while the system or cell is still booting.

Firmware incorporating embodiments of the remote access systems and methods passes flow of control to a low-level firmware DUI in the event of a fatal error or when the DUI is invoked. After saving machine state and arriving at a DUI prompt, the DUI enables an engineer or developer to issue commands, view error logs, view or modify hardware and firmware states, and inject data, in order to avoid problems on subsequent boots. This low-level firmware interface provides such support on a per-cell basis. This allows the engineer or developer to debug a problem on a particular cell without impacting performance and function of other cells or the system. The interface may be provided on each cell through a platform dependent hardware (PDH) console interface. The engineer or developer may be provided the flexibility of treating each cell as a separate “system” for debugging purposes. By providing debug capabilities on a per-cell level, the rest of the system can continue to boot while an individual cell's resources are debugged. Advantageously, the present systems and methods may enable remote access to such a DUI via network connectivity, such as from the console of any cell of the multi-nodal computer system.

The DUI may be deployed on an individual cell level and may not depend upon the existence of a system-wide input/output (I/O) console for support. Each cell may provide its own dedicated interface which may be accessed via the aforementioned manageability subsystem by any cell's console or via network connectivity. However, system-wide console access may also be provided, from any cell console, after cell rendezvous, prior to hand-off to the system OS. Remote DUI access may directly support debugging of a truant cell from any connected location, while normally functioning cells rendezvous and boot the operating system. Conversely, in existing multi-nodal systems, the operating system, not aware of missing cell(s), cannot be used to assist in debugging truant cell(s). Further, system resources may be physically inaccessible due to “hard partition” firewalls that are created during the rendezvous which are used to isolate rendezvoused cells from all other non-rendezvoused cells. The DUI may provide direct interactive access to each truant cell from any number of locations, while the operating system continues to function.

An early access window into a high-end server system's firmware, before boot completion, is provided via the DUI. The interactive DUI may be available before core system firmware passes control to adapters or boot handlers. This window into the boot firmware during the boot process is very helpful; instead of waiting for the entire boot process to complete in order to reach an end user prompt, functionality is available beforehand. A developer or engineer may view or modify the hardware configuration or display information from the firmware interface table (FIT), or similar information, using the DUI. The interactive DUI may also provide a qualification base for code in development. For example, test drivers may be run from the DUI prompt.

Embodiments of the remote access systems and methods enable remote access to the DUI employing a collaborative effort of the aforementioned manageability subsystem. This manageability subsystem may take the form of firmware that acts as an external interface for a cell or the entire multi-nodal computer system. One console per node, or per cell, may be available at the cell's physical console, at the consoles of other cells, and/or via network connectivity. The system firmware may be written to make use of this capability. One or more of the plurality of embodiments of remote DUI access may be built into the firmware of a multi-nodal or cellular architecture computer system. One or more dedicated UART chips may also be employed in each cell such that each UART is a resource that belongs to a cell and such that the cell firmware retains ownership of the UART exclusive of the OS, thereby avoiding conflicts. The DUI uses an interface provided by the UARTs to packetize communications from a cell, to a cell or to a network terminal, in a Telnet protocol compliant format, or the like.

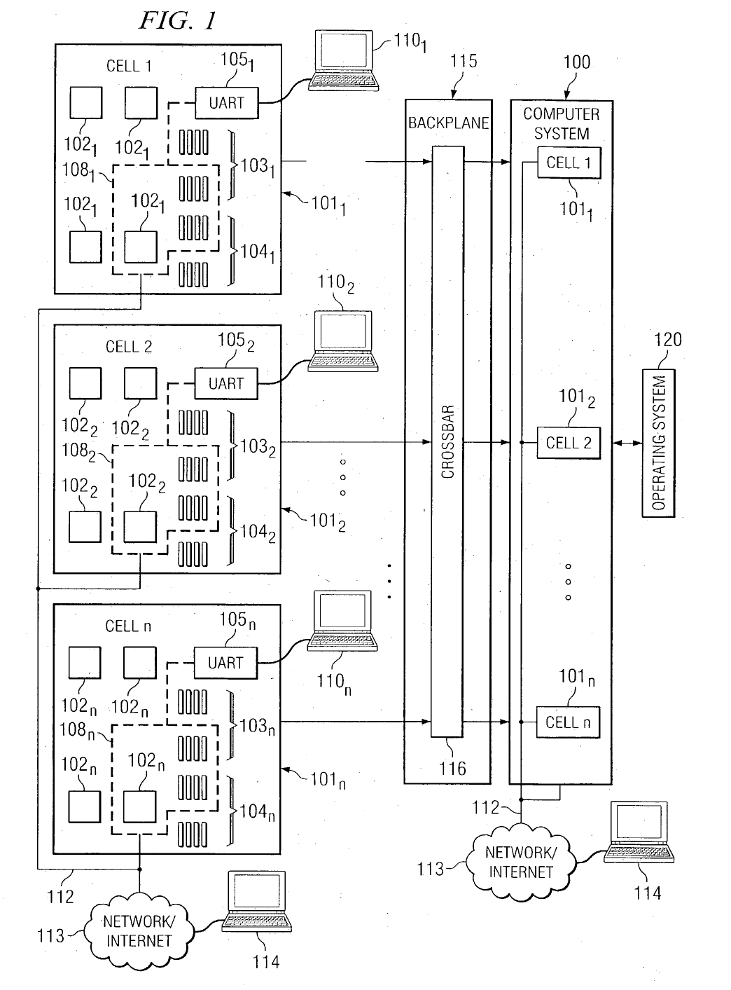

FIG. 1 diagrammatically illustrates a hardware layout of multi-nodal, or cellular architecture, computer system 100 employing systems and methods for remote DUI access. FIG. 1 also illustrates general flow of booting operations of system 100, as well as collaborative manageability subsystem firmware 108₁-108ₙ enabling remote DUI access. Individual cells 101₁-101ₙ are shown. Each cell typically consists of multiple processors 102₁-102ₙ and its own memory 103₁-103ₙ. Each cell 101₁-101ₙ is typically a complete computer that, if properly configured, may be booted as an individual server with its own firmware and operating system. Firmware 104₁-104ₙ runs on each cell until rendezvous, then firmware in a designated “core” cell handles system booting. Each cell may be interconnected to a common system fabric such that system processors all may access any system resource. For example, the cells may be interconnected via backplane 115 or the like. Crossbar 116, which may be embodied as chips on the backplane, allow each cell to communicate with other cells connected to backplane 115. Each cell has a connection via UART 105₁-105ₙ, and a port or the like, to console 110₁-110ₙ where a developer or engineer can interact with each particular cell, another cell or entire system 100, via the DUI, employing the remote access. Access to a cell's firmware via the DUI may be available to that cell's console 110₁-110ₙ via the cell's UART 105₁-105ₙ. Access to other cells may be available via any cell's console and its UART once the cells to be accessed and the cell accessing have all initiated backplane 115. Access to the system by the DUI may be gained once rendezvous of the cells have taken place.

The remote DUI access systems and methods collaboratively employ manageability subsystem 108₁-108ₙ of firmware 104₁-104ₙ and/or memory 103₁-103ₙ and/or at least one cell processor 102₁-102ₙ to provide remote access to any cell at any point in the boot process, or in the event of a boot failure, via any cell's console 110₁-110ₙ. Alternatively, manageability subsystem 108₁-108ₙ may provide remote access via terminal 114 connected to network 113 and/or connectivity 112.

FIG. 1 diagrammatically illustrates an embodiment of collaborative manageability subsystem 108 that may be used for remote access to a firmware developer user interface. An embodiment of subsystem 108₁-108ₙ comprises at least one processor 102₁-102ₙ executing at least a portion of firmware 104₁-104ₙ in each cell 101₁-101ₙ of multi-modal computer system 100. Developer user interface manageability subsystem 108₁-108ₙ provides a shared memory interface that makes use of at least a portion of memory 103₁-103ₙ of one or more cells 101₁-101ₙ. The shared memory interface in turn provides an external interface for each of the cells of computer system 100 UARTS 105₁-105ₙ may packetize communications between the cells and between the cells and any network attached to the computer system.

In the boot of system 100, each cell 101₁-101ₙ has individual firmware 104₁-104ₙ that runs on that cell up to a point, and then at a certain point in the boot process, a core cell, or primary cell, in the system takes over and boots system 100 as a whole. So there are a collection of cells after rendezvous before handing off to OS 120. The core cell handles the boot process after rendezvous and handoff to OS 120. The DUI may be invoked for any cell 101₁-101ₙ via consoles 110₁-110ₙ or terminal 114, or may be invoked if an error occurs in a particular cell or in the rendezvoused cell set, prior to handoff to OS 120. The DUI may make use of an interface provided by UARTs 105₁-105₂ and packetize communication from a cell, to a cell or to a network terminal, in a Telnet protocol compliant format or the like. The manageability subsystem may provide the aforementioned shared memory interface between the system processors employing network 113 and/or the associated network connectivity 112, thereby allowing the processors to interact before initiation of backplane 115 and/or rendezvous. Network 113 and/or network interconnectivity may be a local area network (LAN), a wide area network (WAN), an intranet, the Internet, or the like.

By way of example, if cell 101₁ has been experiencing a memory error during boot, a user may invoke the DUI from any cell 101₁-101ₙ prior to or during initialization of cell memory 103₁ of cell 101₁. As a result the state of the boot process for that cell might be dumped to the screen of the console from which the DUI was invoked for example console 110₂, and control would be handed off to the DUI at console 110₂ via manageability subsystem 108₁ and/or 108₂. At that point the user may have a capability to interact with cell 101₁ from console 110₂. The user may dump a state of particular components of cell 101₁. The user may “peek and poke” memory locations at low levels of memory 103₁. The user may also attach a debugger, such as a non-Unix debugger (GDB), and interact with cell elements to perform source level debugging of firmware 104₁ for cell 101₁. If the problem with cell 101₁ can be addressed at that point, the cell may be put back into the boot process if cells 101₂-101ₙ are waiting for cell 101₁, at a rendezvous point, and system 100 will still boot to OS 120. In this example, if truant cell 101₁ is for example attached to critical resources such as the operating system boot disk or the like, cells 101₂-101ₙ would typically wait. Alternatively, cells 101₂-101ₙ may boot to OS 120 and cell 101₁ may be added online at a later time as discussed below.

Control may be passed to the DUI in a plurality of different manners. For example, flow control may be passed to the DUI in an error scenario. That is, if an error occurs that is fatal enough to the boot process that the boot process is stopped, the boot process state may be dumped to the console screen and flow control is handed over to the DUI as disclosed in detail in co-pending, U.S. patent application Ser. No. ______ [Attorney Docket No. 100111710-1], entitled “FIRMWARE DEVELOPER USER INTERFACE”. In accordance with embodiments of the remote DUI access, firmware 104₁-104ₙ may be set to pass control to a particular console 110₁-110ₙ of system 100 or terminal 114 upon a boot failure employing present collaborative firmware subsystem 108₁-108ₙ.

Another manner to invoke the DUI is by issuing a break command from a console. This break command may be in the form of a keystroke combination or a breakpoint (bp) command inserted into boot flow using the DUI. These latter two manners are disclosed in detail in co-pending, U.S. patent application Ser. No. ______ [Attorney Docket No. 100200765-1], entitled “FIRMWARE DEVELOPER USER INTERFACE WITH BREAK COMMAND POLLING”. In accordance with embodiments of remote DUI access, a break may be set or issued from any console 101₁-110ₙ or terminal 114 to any cell 101₁-101ₙ via the collaborative firmware subsystem 108₁-108ₙ.

The DUI may act as a command line prompt, similar to a DOS prompt or the like, querying the user via the employed console for commands. Alternatively, a user interface shell may be presented. Regardless, the DUI has a set of commands that a user may employ and the DUI may offer a help command that lists and/or explains available commands. The DUI may also have a “reset” command so that the user is able to reset any cell or the system from the DUI prompt. Embodiments of remote DUI access enable use of such a reset command at any point in the boot process to reset any cell or the entire system from any connected console 110₁-110ₙ or terminal 114.

According to various embodiments the remote DUI facility is implemented with a shared-memory interface between the manageability subsystem, comprising, in part, hardware and firmware and at least one operating processor within the target cell. Multiple embodiments for invocation and/or use of the DUI from a remote console are possible. Among these are external attach embodiments and internal demand embodiments.

In an external attach implementation embodiment, a DUI user has access to a Telnet interface, such as a Telnet session on a PC or an X-terminal. The manageability subsystem exposes the DUI interface as a Telnet session on a fixed Internet Protocol (IP) Address that is assigned to the DUI for a cell. This fixed assignment enables the user to direct an attach request to a cell that is known to be, or expected to be operating in a truant condition. Such a truant cell may issue DUI prompt output, and polling for input.

As mentioned above, the manageability subsystem packetizes character-based (UART-like) I/O used by a processor and the IP based network protocols such as Telnet. For example, in a multi-nodal computer system with 16 physical cells, each DUI port might have IP assignments based on a format such as:

XX.YY.ZZ.00; XX.YY.ZZ.01; XX.YY.ZZ.02; . . . XX.YY.ZZ.15

Thus, a DUI user might attempt to connect to the DUI port of, for example, cell 4 by typing a command such as “Telnet XX.YY.ZZ.04”. The network would send IP requests to the manageability subsystem which would route the packets to the appropriate physical cell. If the DUI side of the shared-memory interface was not initialized, then the manageability subsystem would refuse the Telnet session. Otherwise, the manageability subsystem might serve as a “router” and packetizer/depacketizer, passing data between the user and the DUI-controlled operating processor. Once connected to the DUI firmware, the firmware might require a security challenge password to be used, before interaction could begin. Other security measures outside of the DUI, for example, in the Telnet session managed by the manageability subsystem, could challenge a Telnet connection with a login request before entering the above described pass-thru mode. Name servers and assigned host names could also be given by system network administrators. For example, “complex4-dui4” could be the host name assigned to the DUI port of cell 4.

In this embodiment, various failure modes are possible in establishing the connection between the developer user's console and the truant cell. If the Telnet failed to attach, the user would know that the DUI session was not active. This might indicate that the cell is entirely out of service, that the cell had not activated its DUI interface, or that the cell was not truant and has rendezvoused. If the Telnet session attaches, the user may interact with the firmware DUI to control that cell.

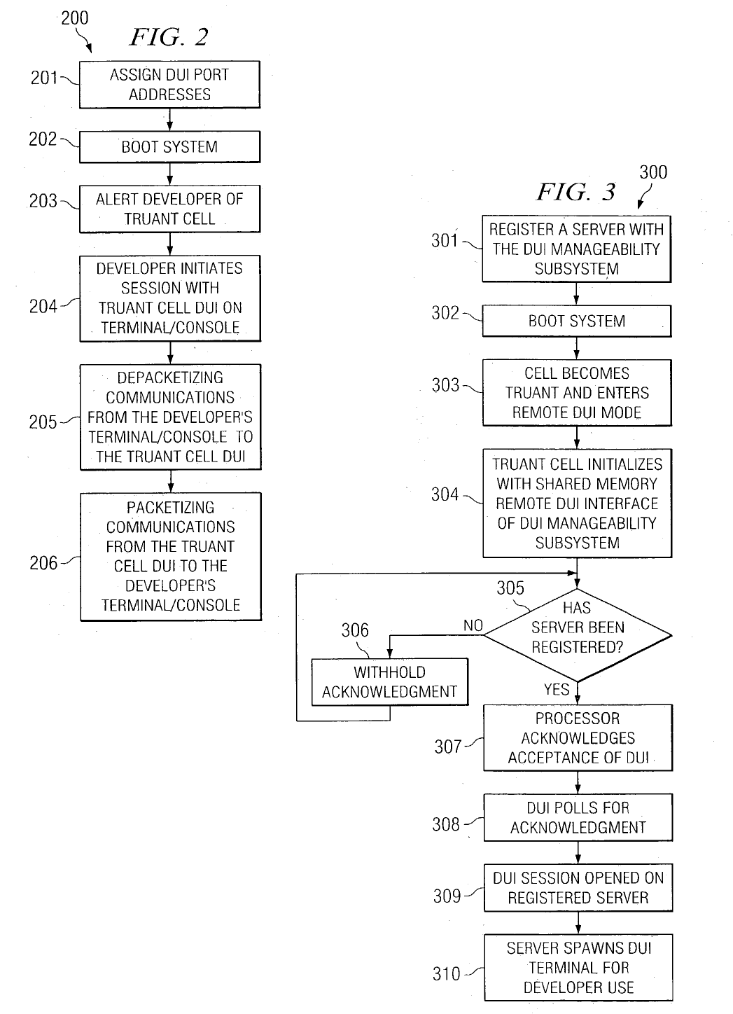

A high level sequence 200 of using an external attached implementation embodiment is illustrated in FIG. 2. Initially Telnet/IP Addresses are assigned to the DUI ports and routed to the manageability subsystem at box 201. When the computer system is booted at 202, a developer user notices at 203, typically through a separate means of providing an alert, that a cell is truant. At 204 the developer enters, on any system console or system connected terminal, a command, such as “Telnet xx.yy.zz.NN”, specifying the correct IP number for the truant cell. Packets from the developer user's Telnet session are directed to the manageability subsystem through the LAN or other network connectivity at box 205. The manageability subsystem depacketizes the data and exposes the “liveness” of the session, such as by issuing a ReceivedCharacterReady command and/or a PortOpen command, to the DUI firmware that should be polling the interface. At box 206 output characters from the DUI are captured, one at a time serially, and packetized into Telnet packets sent back to the developer's Telnet session, providing interaction.

An internal-demand embodiment for implementation of the remote DUI access preferably provides an easy-to-use experience. Ease-of-use has value to most users of complex computer systems. Relative differences in ease-of-use are often noticed and valued, even by firmware designers and experts who would employ this capability. However, this internal demand embodiment requires more intelligence in the manageability subsystem and greater expertise or training on the part of the developer user.

In an internal-demand initiation embodiment, a DUI session is initiated by the operating processor in a truant cell or other cell and not by a DUI user. In this embodiment, a software agent, or proxy, exists between the DUI firmware and a Telnet session of a DUI user. The manageability subsystem causes each DUI port to operate as an X-terminal client. To facilitate this, prior to use of the remote DUI, an X-server registers itself with the manageability subsystem. When a cell fails to rendezvous, or at anytime the firmware executing in a processor in a cell calls for initiation of to initiate a DUI session, the firmware initializes its remote DUI interface by writing an initialization sequence to the shared memory interface. The manageability subsystem interprets this to mean the DUI wishes to interact with the X-server. So the manageability subsystem then sends an X-windows protocol sequence for the specific display corresponding to the DUI port to the previously registered x-server. A developer using the display will experience an “X-terminal pop-up” on the console monitor. This X-terminal will then provide an interactive, Telnet based (secure shell (SSH) based, or other protocol based) DUI session for the cell that spawned the session. In this embodiment there is little likelihood of a failure to connect to a DUI session, because the DUI session exists before the X-window or Telnet session exists. This facilitates ease of use.

There are many variations possible for registering the X-server with the manageability subsystem. Since normal use of multi-cell computer systems typically involves simultaneous development by different engineers, it may be expected that more than one X-server may be registered with the manageability subsystem at a time. Each registration might employ multiple namings of the IP number of the X-server, and the IP number of each of the DUI ports for which the server is offering, or being required to provide, X-windows, resulting in conflicts. The manageability subsystem may have, by way of example, two modes for self checking during registration to avoid such conflicts. Either all of the ports would be owned by a single X-server, or ports may be grouped by partition. Therefore, a developer could only connect to DUI ports that belonged to a single partition and not inadvertently appropriate the ports of another developer.

In FIG. 3, a high level sequence of initiation 300 of a DUI session in accordance with an internal demand initiation embodiment is illustrated. At box 301 a developer invokes a “register my X-server” request to the manageability subsystem. This may be accomplished by the developer user sending a command to the manageability subsystem such as “registerDUIserver(myServerIP, DuilPx, DuilPy, . . . )”. At box 302 the system boots and a cell fails to rendezvous, becoming truant, or otherwise enters a “remote DUI mode”, or the like, at box 303. In this remote DUI mode the truant cell writes an initialization sequence to its shared memory remote-DUI interface at box 304. At box 307 the processor executing the manageability subsystem sees the initialization and acknowledges its acceptance. However, if it is determined at 305 than an X-server has not been registered at 301 above, then no server exists for this DUI prompt, and the initialization acknowledgement is withheld at 306 until a registration occurs. In one embodiment of the DUI-manageability subsystem interface, the DUI firmware might poll, at box 308, on a ‘bit’ that signals acknowledgement of the initialization. At 309 the processor executing manageability subsystem sends an ‘OpenXSession’ request to the X-server that previously registered to host an X-client for a truant cell. The X-server spawns an X-terminal on the server's display monitor at 310 and the developer user may interact with the DUI session.

The above sequence may enable any number of DUI sessions and/or truant or otherwise halted cells to pop-up an X-terminal without requiring a developer user to issue a Telnet, or other, command to each cell. The developer is not required to speculate as to whether or not the DUI is active or inactive, in order to initiate the session. Every session that exists is immediately “live” because the cell firmware initiates the session internally, and the cell firmware directs initiation of the session. However, the network, the manageability subsystem, and the remote Telnet server need not take part in initiation until called upon. This internally initiated remote DUI access embodiment gives a developer more control over the system during debug operations because the user knows whether the firmware is executing properly and is not required to speculate.

When a cell has become truant, but a developer or technician knows that the cell was intended to become part of the rendezvoused set, that user may use the DUI interface to ‘add’ the cell without a need to interact with system management software. The cell might appear to the system OS as an online added resource and the OS might refuse to accept the cell as part of the system if the OS does not support online addition. Alternatively, the OS might accept the added cell, and incorporate the resources into the now running OS. Whereas a developer user may interact with a cell directly using a remote DUI interface in accordance with the present system and methods, a customer support engineer may be enabled to “fix” a problem inside a truant cell employing remote DUI access. The cell may then be added to the running partition without forcing the OS to participate in a significant reconfiguration sequence, possibly avoiding a reboot, or significant interactions with various subsystems that share the system profile structure. Thus, a combination of remote DUI access systems and methods with OS-support for online cell addition may be used to avoid a system reconfiguration and possibly a system reboot when rendezvousing a truant cell.

What is claimed is:

1. A method for remote access to a firmware developer user interface in a multi-nodal computer system, comprising:
registering a server with a developer user interface manageability subsystem of said multi-nodal computer system;
booting said multi-nodal computer system;
entering, by a truant cell of said multi-nodal computer system, into a remote developer user interface mode;
writing, by said truant cell, a remote developer user interface initialization sequence to shared memory of said manageability subsystem;
acknowledging, by a processor of said manageability subsystem, acceptance of said initialization upon said registering;
sending an open session request to said server; and
spawning an interactive developer user interface terminal session on said server.

2. The method of claim 1 further comprising packetizing communications to and from said developer user interface.

3. The method of claim 2 wherein said packetizing comprises packetizing said communications into a Telnet format.

4. The method of claim 2 wherein said packetizing is carried out by at least one universal asynchronous receiver-transmitter in a cell of said multi-nodal computer system.

5. The method of claim 2 wherein said packetizing is carried out by at least one serial connection in a cell of said multi-nodal computer system.

6. The method of claim 5 wherein said serial connection is a universal serial bus.

7. The method of claim 5 wherein said serial connection is a high performance serial bus.

8. The method of a claim 1 wherein said server is connected to said multi-nodal computer system via a network.

9. The method of claim 8 wherein said network is the Internet.

10. The method of claim 8 wherein said network is a local area network.

11. The method of claim 1 wherein said acknowledging comprises polling by said manageability subsystem on a bit that signals acknowledgment of said initialization.

12. A method for remote access to a firmware developer user interface in a multi-nodal computer system, comprising:
assigning addresses to developer user interface ports in said multi-nodal computer system;
routing said addresses to a developer user interface manageability subsystem of said multi-nodal computer system;
booting said multi-nodal computer system;
entering, by a user, an initiation command, indicating one of said addresses, in a terminal associated with said multi-nodal computer system;
depacketizing, by said manageability subsystem, data from said terminal;
polling by developer user interface of a truant cell of said multi-nodal computer system; and
packetizing output of said developer user interface for communication to said terminal.

13. The method of claim 12 wherein said packetizing comprises packetizing said communications into a Telnet format.

14. The method of claim 12 wherein said packetizing is carried out by at least one universal asynchronous receiver-transmitter in a cell of said multi-nodal computer system.

15. The method of claim 12 wherein said packetizing is carried out by at least one serial connection in a cell of said multi-nodal computer system.

16. The method of claim 15 wherein said serial connection is a universal serial bus.

17. The method of claim 15 wherein said serial connection is a high performance serial bus.

18. The method of a claim 12 wherein said terminal is connected to said multi-nodal computer system via a network.

19. The method of claim 18 wherein said network is the Internet.

20. The method of claim 18 wherein said network is a local area network.

21. A system for remote access to a firmware developer user interface comprising
at least one processor executing firmware in each cell of a multi-modal computer system;
a developer user interface manageability subsystem providing a shared memory interface, said shared memory interface in turn providing an external interface for each of said cells of said computer system; and
communications functionality packetizing communications between said cells and between said cells and any network attached to said computer system.

22. The system of claim 21 further comprising network connectivity provided between said processors and a network.

23. The system of claim 22 wherein said network comprises the Internet.

24. The system of claim 22 wherein said network comprises a local area network.

25. The system of claim 24 wherein said local area network comprises at least one cell of said computer system.

26. The system of claim 21 wherein said communications functionality packetizes said communications in a Telnet format.

27. The system of claim 21 wherein said communications functionality comprises a universal asynchronous receiver-transmitter

28. The system of claim 21 wherein said communications functionality is at least one serial connection in at least one cell of said multi-nodal computer system.

29. The system of claim 28 wherein said serial connection is a universal serial bus.

30. The system of claim 28 wherein said serial connection is a high performance serial bus.
